(19) United States
(12) Patent Application Publication
(10) Pub. No.: US 2013/0157106 A1
(43) Pub. Date: Jun. 20, 2013

(54) LITHIUM METAL POWDER-CARBON POWDER COMPOSITE ANODE FOR LITHIUM SECONDARY BATTERY AND LITHIUM METAL SECONDARY BATTERY COMPRISING THE SAME

(71) Applicants: Young Gi Lee, Daejeon (KR); Kwang Man Kim, Daejeon (KR); Yil Suk Yang, Daejeon (KR); Jong Kee Kwon, Daejeon (KR); Jong Dae Kim, Daejeon (KR)

(72) Inventors: Young Gi Lee, Daejeon (KR); Kwang Man Kim, Daejeon (KR); Yil Suk Yang, Daejeon (KR); Jong Kee Kwon, Daejeon (KR); Jong Dae Kim, Daejeon (KR)

(73) Assignee: ELECTRONICS AND TELECOMMUNICATIONS RESEARCH INSTITUTE, Daejeon (KR)

(21) Appl. No.: 13/478,581

(22) Filed: May 23, 2012

(30) Foreign Application Priority Data
Dec. 14, 2011 (KR) 10-2011-0134959

(51) Int. Cl. H01M 10/058; H01M 10/0569; H01M 2/16; H01M 4/131; H01M 4/133; H01M 4/134; H01M 10/0566; H01M 10/0568

(52) U.S. Cl. 429/144; 429/211; 429/337; 429/342

(57) ABSTRACT

Provided are an anode in which lithium metal powder and carbon powder are physically mixed with each other to form a composite and the composite is applied as an anode layer, and a lithium metal secondary battery including the anode. The anode of the present invention may suppress the formation of lithium dendrites and the change in volume of cells generated in a rechargeable battery which uses a lithium metal anode and significantly improve the cycle life-span of a lithium metal secondary battery by physically mixing lithium metal particles and carbon particles having an equivalent average particle diameter with each other to be applied as an anode layer.

### CROSS-REFERENCE TO RELATED APPLICATIONS

This application is based on and claims priority from Korean Patent Application No. 10-2011-0134959, filed on Dec. 14, 2011, with the Korean Intellectual Property Office, the present disclosure of which is incorporated herein in its entirety by reference.

### TECHNICAL FIELD

The present invention relates to an anode including an anode layer which contains lithium metal particles and carbon particles and a method for manufacturing a lithium metal secondary battery including the same, and more particularly, to an anode in which lithium metal powder and carbon powder, having a micro-unit average particle diameter, are physically uniformly mixed with each other and coated together with a conductive agent and a binder on a current collector to be bonded to each other, and a lithium metal secondary battery including the anode to improve the performance and stability of the battery.

### BACKGROUND

Lithium metal secondary batteries are the first commercialized lithium secondary batteries, and use lithium metal as an anode. However, since lithium metal secondary batteries have volume expansion of cells due to lithium dendrites formed on the surface of the lithium metal anode, gradual decrease in capacity and energy density, short generation due to the steady growth of dendrites, and reduction of cycle life-span and generation of cell stability issue (explosion and ignition), the production of lithium metal secondary batteries has stopped only a few years after the commercialization thereof. Instead of this lithium metal, carbon-based anodes, which are safer and in which lithium may be stably stored in an ionic state in lattice and void space, have been used and the full-scale commercialization and dissemination of lithium secondary batteries has progressed due to the use of the carbon-based anode.

Until now, carbon-based or non-carbon anode materials for lithium secondary batteries have become a mainstream. Most of the developments of anode materials has been focused on carbon-based (graphite, hard carbon, soft carbon, and the like) and non-carbon-based (silicon, tin, titanium oxide, and the like) materials. However, carbon-based materials have not succeeded in obtaining more than a theoretical capacity of 400 mAh per g, while non-carbon-based materials are materials having more than a theoretical capacity of 1,000 mAh per g. However, in the non-carbon-based materials, the volume expansion and performance problems during charge and discharge have not been solved. Further, recently, as medium and large lithium secondary batteries have been actively marketed, high capacity and high energy density characteristics have been required. However, conventional materials have many limitations in satisfying these performances.

Recently, studies on reutilizing lithium metal as the lithium-air battery have been actively performed. Lithium is very light and has a theoretical capacity of more than 3,800 mAh per g, and thus the lithium metal has the possibility of realizing a very excellent energy density. Therefore, movement of restudying the lithium metal secondary battery itself along with research and development of these lithium-air batteries has actively progressed.

However, there are a lot of problems to be overcome in order to apply the lithium metal to the anode material for a rechargeable battery. Since the lithium metal anode allows lithium in the form of ions, which has been released from the cathode, to be converted into neutral lithium through an electro-chemical reaction with electrons supplied from the external conducting wire unlike graphite-based anode materials, very irregular lithium aggregates are easily formed in the form of dendrites on the surface of lithium during charge. Since the uneven surface thus-formed generally provides an expanded volume and ions are not selectively detached from lithium dendrites and are more often directly dissociated from the lithium metal during discharge, not only a very extreme volume change is generated on the surface of the lithium anode while undergoing a series of charge and discharge, but also the dendrites formed show irregular and complex morphology. The complex aspect of the surface is not stabilized at all as the cycle progresses and the generation and extinction is steadily repeated, thereby exhibiting a very irregular cycle life-span. Further, lithium dendrites formed during discharge are detached in bulk into the electrolyte region while being dissociated, and the dendrites keep growing in the vertical direction and pass through a separator to be directly or indirectly in contact with the surface of the cathode which is disposed on the opposite side, thereby causing a hard short or a soft short.

### SUMMARY

The present invention has been made in an effort to simultaneously improve the performance and safety of a battery while suppressing the formation of irregular lithium dendrites on the lithium anode and maintaining uniform morphology during charge and discharge by realizing a lithium-based anode from application of various wet methods to a lithium metal-carbon composite formed by mixing lithium metal particles and carbon particles.

Other technical problems which the present invention attempts to solve are not limited to the technical problems which have been mentioned above, and still other technical problems which have not been mentioned will be apparently understood to those skilled in the art to which the present invention pertains from the following description.

An exemplary embodiment of the present invention provides an anode for a lithium metal secondary battery, comprising: a current collector; and an anode layer that is formed on the current collector and contains lithium metal particles and carbon particles, wherein the anode layer comprises lithium metal particles having an average particle diameter of from 5 μm to 50 μm and carbon particles having an average particle diameter of from 5 μm to 30 μm, and the lithium metal particles and the carbon particles are uniformly mixed with each other to be physically linked.

A mixing ratio of the lithium metal particles (Li) and carbon particles (C) used may be in a range of from 1 to 99:from 99 to 1 and preferably in a range of from 1 to 70:from 30 to 99 (weight ratio).

The lithium metal particles may have a core-shell structure comprising lithium metal particles and a surface protective layer which surrounds the lithium metal particles and contains wax or silicon oil.

The carbon particles may be one or more selected from the group consisting of graphite, hard carbon and soft carbon.

The anode layer according to an exemplary embodiment of the present invention may be formed by coating or screen printing a slurry or paste containing lithium metal particles and carbon particles on a current collector.

The anode layer may further include a conductive agent, and In this case, the conductive agent may have an average diameter of several to several ten nanometer (nm) unit.

Another exemplary embodiment of the present invention provides a lithium metal secondary battery, comprising: an anode comprising an anode layer in which lithium metal particles having an average particle diameter of from 5 μm to 50 μm and carbon particles having an average particle diameter of from 5 μm to 30 μm are uniformly mixed with each other to be physically linked; a cathode; a separator interposed between the cathode and the anode; and an electrolyte injected therebetween.

The lithium metal secondary battery may constitute a pouch shape cell by disposing an anode current collector and an anode formed on the anode current collector, a cathode current collector and a cathode formed on the cathode current collector, and a separator interposed therebetween, separating a physical contact of the cathode and the anode to stack cells, and then finally injecting an electrolyte thereinto.

The lithium metal secondary battery of the present invention may suppress the rapid formation of dendrites of the lithium anode to suppress the volume expansion of the anode and may also suppress the steady growth of dendrites to improve the cycle life-span of the lithium metal secondary battery and the safety from explosion and ignition of cells thereof.

In terms of process, various wet methods such as a slurry coating method, a screen printing method of paste, and the like may be all applied to uniformly coat composite particles without causing corrosion or reaction on the surface of lithium, thereby improving the simplicity and mass productivity of the manufacturing process of the lithium metal-based anode.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a side cross-sectional view of a conventional lithium metal anode in the related art.

FIG. 2 is a side cross-sectional view of the anode for a lithium metal secondary battery according to an exemplary embodiment of the present invention.

FIG. 3 is a top view and a side view of physical structure properties of an anode plate finally obtained after roll pressing an anode plate constituted by using lithium metal particles and carbon particles having an equivalent average particle diameter according to an exemplary embodiment of the present invention.

FIG. 4 is a top view and a side view of physical structure properties of an anode plate finally obtained after roll pressing an anode plate constituted by using lithium metal particles and carbon particles having different average particle diameters according to another exemplary embodiment of the present invention.

FIG. 5 is a top view and a side view of physical structure properties of an anode plate finally obtained after roll pressing an anode plate constituted by using lithium metal particles and carbon particles having different average particle diameters according to yet another exemplary embodiment of the present invention.

FIG. 6 is a graph evaluating cycle properties of lithium metal secondary batteries including anodes in Examples 1 to 4 and Comparative Examples 1 and 2, respectively.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

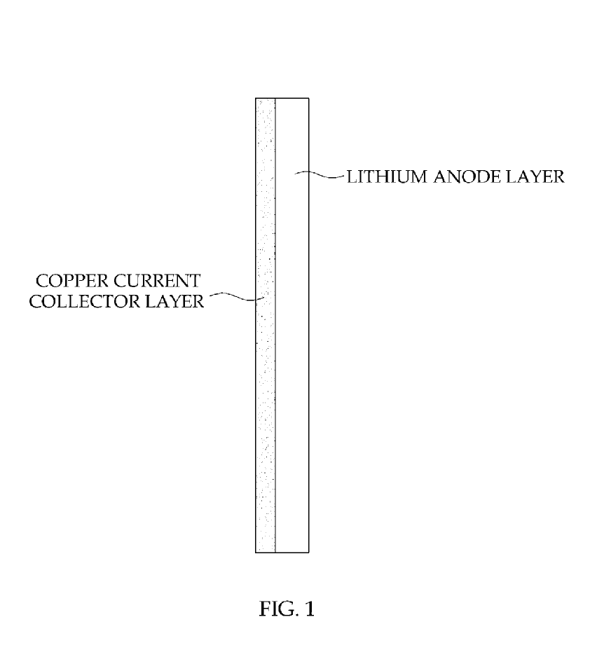

FIG. 1 is a side cross-sectional view of a conventional lithium metal anode in the related art.

As shown in FIG. 1, the conventional lithium metal anode in the related art includes an anode current collector and a lithium metal layer formed on the current collector. Generally, the lithium metal layer uses a lithium foil, and the lithium foil causes a formation of irregular lithium dendrites during charge and discharge, and thus a change in volume is so severe that problems on the performance and safety of the battery occur.

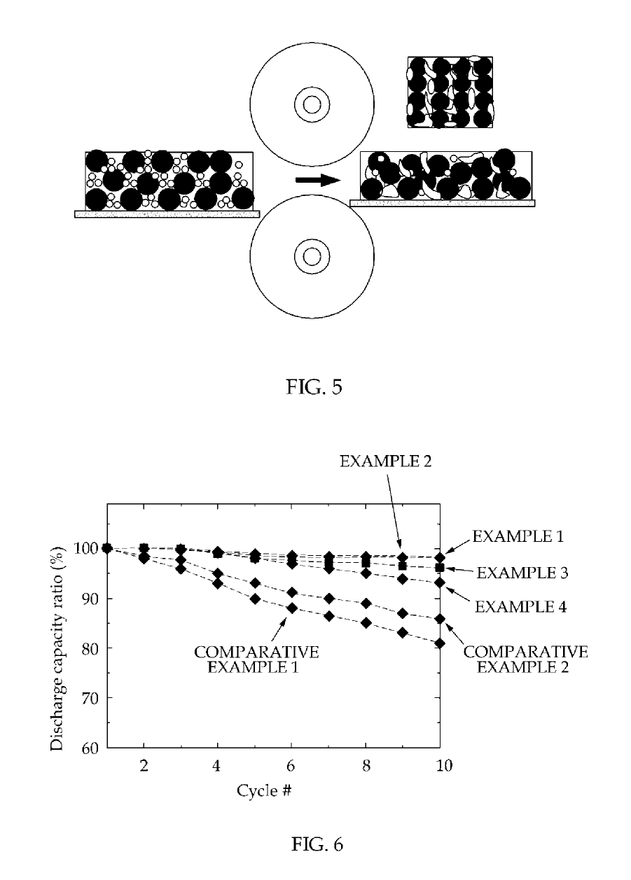

The present invention has been made in an effort in consideration of the above-described problems, suppress the formation of dendrites on the lithium layer, and maintain a uniform morphology by using lithium metal particles and carbon particles as anode layer components. However, if lithium metal particles and carbon particles having relatively different sizes are used as an anode layer, lithium metal particles are aggregated with each other to cause an aggregation phenomenon irrespective of the presence of carbon particles, making it difficult to form an anode layer itself, and a problem that lithium metal particles are pressed during roll pressing of the anode plate and thus the lithium metal particles have a shape of an electrode plate like a foil still occurs (see FIGS. 4 and 5).

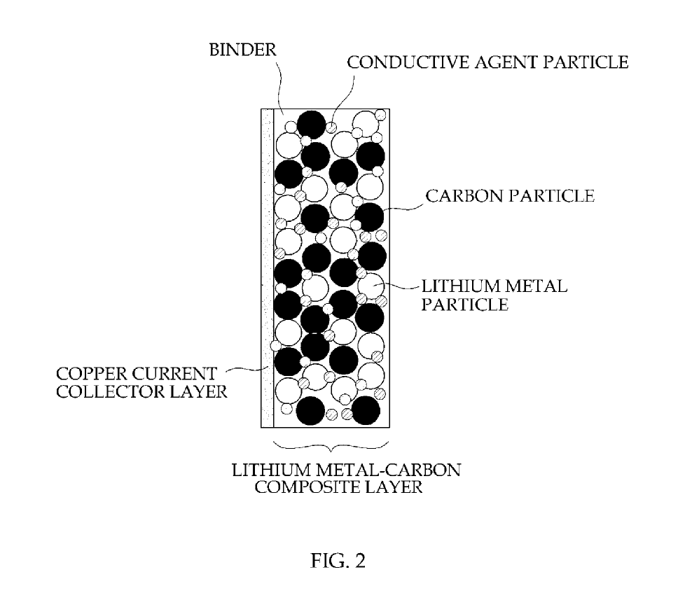

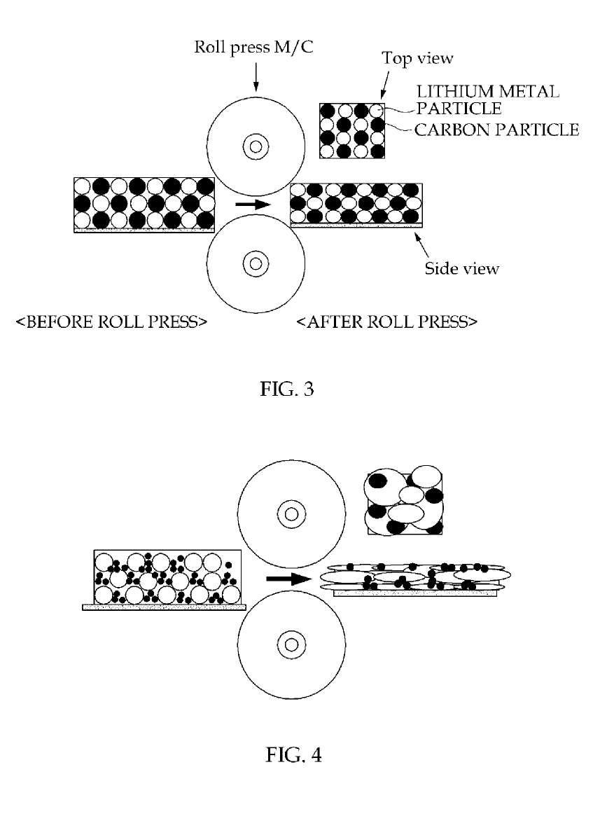

Thus, it has been recognized in the present invention that the above-described problems of lithium metal particles such as aggregation and having a shape of an electrode plate are associated with the control of a relative size (average particle diameter) between lithium metal particles and carbon particles to be used. Accordingly, lithium metal micron particles and carbon micron particles having an equivalent size are used as anode layer components in the present invention (see FIGS. 2 and 3).

If lithium metal micron particles and carbon micron particles having an equivalent size are used as in the present invention, a cohesive force by which lithium metal particles are aggregated may be removed by dimension of carbon particles and a problem that lithium particles have a shape of an electrode plate may also be solved by carbon particles functioning as a support. The rapid formation of lithium dendrites may be suppressed by introducing carbon particles, and a substantial portion of a volume expansion/contraction problem or short of cells and cycle life-span deterioration problem may also be suppressed.

A higher electrical conductivity may be exhibited, compared to the case where lithium metal particles are used alone.

FIG. 2 is a side cross-sectional view illustrating the configuration of a lithium anode according to an exemplary embodiment of the present invention.

The anode of the present invention comprises an anode current collector and an anode layer which is formed on the current collector and contains lithium metal particles and carbon particles.

The anode layer according to an exemplary embodiment of the present invention has a structure in which lithium metal micron particles and carbon micron particles are uniformly mixed to be physically linked to each other (see FIG. 2-3), and the lithium metal particles and carbon particles may use micron (μm) particles which have an equivalent average particle diameter as much as possible. As used herein, the term “the micron particles” refers to particles having an average particle diameter of several micrometer to several ten micrometer (μm) unit.

The lithium metal particles are not particularly limited as long as the particles have a micrometer unit, and the average particle diameter may be in a range of, for example, from 5 μm to 50 μm. Preferably, the average particle diameter may be in a range of from 5 μm to 25 μm.

The carbon particles are not particularly limited as long as the particles have an almost equivalent size with the lithium metal particles, and the average particle diameter may be in a range of, for example, from 5 μm to 30 μm. Preferably, the average particle diameter may be in a range of from 10 μm to 25 μm.

The mixing ratio of the lithium metal particles (Li) and carbon particles (C) used, which constitute the anode layer, may be in a range of from 1 to 99:from 99 to 1 (weight ratio) and preferably in a range of from 1 to 70:from 30 to 99 (weight ratio). In this case, even a small amount of lithium metal particles which is added thereinto may realize the effect of a high capacity of the anode due to the high capacity of Li.

As the lithium metal particles, lithium metal particles typically used in the art, or lithium metal particles on which a surface protective layer is formed may be used without any limitation.

In this case, the lithium metal particles with a surface protective layer formed thereon may have a core-shell structure comprising lithium metal particles and a surface protective layer which surrounds the lithium metal particles and contains wax or silicon oil. If wax or a silicon oil layer is present on the particle surface as described above, a property that lithium particles are aggregated by the protective layer may be alleviated. Since wax or a silicon oil layer which is present on the surface of the lithium metal particle is electrically non-conductive, a drop in conductivity of the anode may be caused. However, some portions of the protective layer are dissolved by a dispersion medium when a slurry or paste is prepared by wet processes, and thus the conductivity of the anode finally manufactured is little affected.

According to an exemplary embodiment of the present invention for preparing the lithium metal particles having a core-shell structure, the preparation may be carried out by putting a lithium foil into an oil fluid at a high temperature, stirring the resulting mixture to form a molten droplet and followed by quenching. In this case, lithium metal particles having various sizes may be obtained according to the kind of oil fluid, temperature, and difference in stirring speed, and the kind of this oil fluid, temperature, and stirring speed may be suitably controlled by materials or conditions which are generally known in the art.

The component of the carbon particle is not particularly limited, and for example, graphite, hard carbon, soft carbon or a mixed form of one or more thereof may be used.

The anode layer of the present invention may further include a conductive agent typically known in the art, in addition to the above-described lithium metal particle and carbon particle.

In this case, the conductive agent may have an average particle diameter and component, which are similar to those of conductive agents used in the art. For example, the average particle diameter of the conductive agent may be in a range of from 5 nm to 30 nm and preferably from 10 nm to 25 nm The conductive agent may be controlled to an amount of 10 parts by weight or less based on the total parts by weight of the anode layer and used in the amount.

The anode layer according to an exemplary embodiment of the present invention may be formed by coating or screen printing a slurry or paste containing lithium metal particles and carbon particles on a current collector. In the present invention, a wet-process slurry coating may be performed through the combination of lithium metal particles and carbon particles or a screen printing may be performed through manufacture of the particles into a paste and thus, a lithium-based anode is readily manufactured. Further, it is advantageous in that inexpensive continuous processes may be designed without any chemical damage or deterioration in performance in the lithium anode.

The current collector with the anode layer formed thereon is not particularly limited, as long as a lithium-containing layer may be formed thereon with a good cohesion. Non-limiting examples of the current collector include at least one selected from copper, nickel, stainless steel, molybdenum, tungsten, and tantalum. At that time, since a current collector formed of a material which is not alloyed with lithium and having a small thickness needs to be used, a copper foil, a copper foil having a coarse surface, or an electrolytic copper foil may be used.

The lithium anode according to an exemplary embodiment of the present invention may be manufactured by mixing lithium metal micron particles and carbon micron particles having a size equivalent to an average particle diameter of the lithium metal particles to prepare a slurry or paste, then coating the slurry or paste prepared on a current collector, and drying the slurry or paste. However, the lithium anode is not limited thereto.

Hereinafter, according to an exemplary embodiment of the present invention, lithium metal particles and carbon particles are physically uniformly mixed, and then a binder and a conductive agent are added with a co-solvent thereto to prepare a slurry or paste.

In this case, components which are generally known in the art may be used for the binder and conductive agent without any limitation, and a binder and conductive agent components may be used. A method or conditions for preparing a slurry and/or paste may be used according to methods which are typically known in the art.

Thereafter, the slurry or paste prepared is coated or coated on a current collector by using a screen printing technique. In this case, the thickness of the anode layer formed is not particularly limited, but may be in a range of, for example, from 10 μm to 200 μm. Although the explanation has been focused on slurry coating or screen printing method of the paste in the present invention, the manufacture of the anode by applying various wet methods other than the methods also falls within the scope of the present invention.

Next, an anode is manufactured by drying the coated current collector, applying a release film on both sides of the dried anode plate, and allowing the plate to pass through a roll press to be finally pressurized.

Meanwhile, FIGS. 3 to 5 are top views and side views illustrating physically structural properties of an anode plate finally obtained after roll pressing an electrode plate by means of a relative size between lithium metal particles and carbon particles in the anode according to an exemplary embodiment of the present invention.

FIG. 4 shows a case in which an anode layer is constituted by mixing lithium metal particles and carbon particles and the average particle diameter of lithium particles is larger than the average particle diameter of carbon particles. In this case, it can be seen that that lithium metal particles are pressed to have a shape of an electrode plate like a foil during roll pressing of the anode plate due to a relatively small volume of carbon particles, irrespective of the presence of carbon particles.

FIG. 5 shows a case in which an anode layer is constituted by mixing lithium metal particles and carbon particles and the average particle diameter of carbon particles is larger than the average particle diameter of lithium metal particles. In this case, it can be seen that due to a difference in relative size between lithium particles and carbon particles, a problem that lithium metal particles are aggregated with each other occurs, irrespective of the presence of carbon particles, and accordingly, the aggregated lithium metal particles during roll pressing of an anode plate are pressed together to be distributed in the form of irregular thin pieces or flake.

On the other hand, FIG. 3 shows the anode of the present invention constituted by using lithium metal particles and carbon particles, which have an equivalent size average particle diameter. In this case, it can be seen that an aggregation phenomenon of lithium metal micron particles and a problem that lithium metal particles have a shape of an electrode plate may be simultaneously solved by carbon micron particles.

An exemplary embodiment of the present invention provides a lithium metal secondary battery including an anode, a cathode, a separator interposed between both of the electrodes, and an electrolyte, manufactured as described.

A lithium metal secondary battery may be manufactured by a conventional method known in the art, and according to a preferred exemplary embodiment, a separator is interposed between both the electrodes to assemble a body, and then an electrolyte is injected into the assembled body to manufacture the battery.

A cathode to be applied along with the above-described anode is not particularly limited, but may have a form that a cathode layer is bound on a current collector.

In this case, when a method for manufacturing a cathode is specifically described, the cathode may be manufactured by dispersing a cathode material including a cathode active material, selectively a binder and/or a conductive agent, and the like, in a solvent or a dispersion medium, for example, N-methyl pyrrolidone (NMP) to prepare a cathode slurry, coating the prepared slurry on a cathode current collector, subjecting the coated current collector to a heat treatment process, and followed by pressing.

In this case, for the cathode layer, a cathode active material which may be typically used in the cathode of a lithium metal secondary battery in the related art is available. Non-limiting examples of the available cathode active material include a lithium-containing metal composite oxide selected from the group consisting of olivine (LiFePO₄), carbon particle-coated nanosize olivine (LiFePO₄), lithium cobalt oxide (LiCoO₂), lithium nickel oxide (LiNiO₂) and lithium manganese oxide (LiMn₂O₄), a mixture of the lithium-containing metal composite oxide, a solid solution of the lithium-containing metal composite oxide, or a material with aluminum, iron, copper, titanium, and magnesium substituted in the solid solution.

As a non-limiting example of the available conductive agent, one or more selected from the group consisting of graphite, hard carbon, soft carbon, carbon fiber, carbon nanotubes, carbon black, acetylene black, Ketchen black and lonza carbon may be selected.

Non-limiting examples of the binder include polyvinylidene fluoride, a copolymer of vinylidene fluoride and hexafluoro propylene, polyvinyl chloride, polyvinyl alcohol, polyvinyl acetate, ethylvinyl acetate, carboxymethyl cellulose, styrene/butadiene rubber/carboxymethyl cellulose, or a mixture of one or more kind thereof. In this case, the ratio of the used cathode active material, the conductive agent and the binder that constitute the cathode layer may be used within the range which is generally used in the art, and may be preferably in a range of from 8:1:1 to 9.8:0.1:0.1 as a weight ratio.

In the lithium metal secondary battery according to an exemplary embodiment of the present invention, a polyethylene-based single film or a multilayer film of polyethylene and polypropylene may be applied to the separator. The preferred thickness of the separator may be in a range of from 16 μm to 25 μm, but is not particularly limited thereto.

In the lithium metal secondary battery according to an exemplary embodiment of the present invention, the electrolyte may be in the form of a lithium salt dissolved or dissociated in an organic solvent.

Non-limiting examples of the available organic solvent include ethylene carbonate, propylene carbonate, dimethyl carbonate, diethyl carbonate, ethyl methyl carbonate, tetrahydrofuran, 2-methyltetrahydrofuran, dimethoxyethane, methyl formate, ethyl formate, γ-butyrolactone, or a mixture of one or more thereof.

Non-limiting examples of the available lithium salt include lithium perchlorate (LiClO₄), lithium triflate (LiCF₃SO₃), lithium hexafluorophosphate (LiPF₆), lithium tetrafluoroborate (LiBF₄), lithium trifluoromethanesulfonyl imide (LiN(CF₃SO₂)₂), and a mixture of one or more thereof. The concentration of the lithium salt in the electrolyte is preferably in a range of from 1 M to 1.5 M.

Hereinafter, a method for manufacturing a lithium metal secondary battery according to an exemplary embodiment of the present invention will be described in more detail with reference to specific Examples. However, the following Examples are provided for the purpose of easily understanding the present invention, and the scope of the present invention should not be construed to be limited thereto. Various modifications and changes can be made without departing from the spirit of the present invention.

### PREPARATIVE EXAMPLE 1

For preparation of lithium metal particles, a 1 L-volume reactor was put into an oil bath set at 180° C., the reactor was filled with silicon oil and then stirred at a constant speed of about 200 rpm to be maintained for 10 hr. Subsequently, 10 g of lithium foil was introduced thereto, the reactor was stirred again for 5 hr or more, and it was confirmed that the foil had been completely melted and maintained as dispersion in the form of a droplet. Thereafter, the reactor was water-cooled to decrease the temperature of oil in the reactor to room temperature, and then the oil was filtered and dried in a drying room. The dried powder was prepared while maintaining particles with a micro size, on which a thin silicon oil coating film was formed on the surface thereof, and could be stored for a long time without particles being aggregated with each other.

### EXAMPLE 1

### Manufacture of Composite Anode of Lithium Metal Particles-MCMB Particles and Lithium Metal Secondary Battery

50 parts by weight of spherical lithium metal particles having an average particle diameter of 5 μm, which had been prepared in Preparative Example 1, and 50 parts by weight of mesocarbon microbeads (MCMB) artificial graphite particles having an average diameter of 10 μm were introduced into a disperser, stirred for a predetermined time, and then physically uniformly mixed to form a composite. 5 wt % of Super P as a conductive agent and 5 wt % of polyvinylidene fluoride as a binder were dissolved in NMP, 90 wt % of a lithium metal-MCMB composite was mixed therein to prepare a slurry, and the slurry was coated on a copper current collector to form an single-side anode plate having a thickness of 15 μm. The anode thus-manufactured was cut into a size of 2.0 cm×2.0 cm.

5 wt % of polyvinylidene fluoride was dissolved in NMP, 90 wt % of lithium cobalt oxide (LiCoO₂), 5 wt % of graphite as a conductive agent, and 5 wt % of polyvinylidene fluoride as a binder were mixed therein to prepare a slurry, and then the slurry was coated on the aluminum current collector to form a single-side oxide cathode plate having a thickness of 30 μm. The cathode thus-manufactured was cut into a size of 1.8 cm×1.8 cm. A polyethylene separator having a size of 2.2 cm×2.2 cm was placed between both the electrode plates to be stacked and an electrolyte was finally injected therein to manufacture a lithium metal rechargeable battery of Example 1.

### EXAMPLE 2

### Manufacture of Composite Anode of Lithium Metal Particles-MCMB Particles and Lithium Metal Secondary Battery

An anode and a lithium metal secondary battery including the anode were manufactured in the same manner as in Example 1, except that the weight ratio of the lithium metal particles and MCMB artificial graphite was controlled to 30:70, instead of 50:50.

### EXAMPLE 3

### Manufacture of Composite Anode of Lithium Metal Particles-KS 6 Particles and Lithium Metal Secondary Battery

An anode and a lithium metal secondary battery including the anode were manufactured in the same manner as in Example 1, except that 50 parts by weight of graphite particles (KS-6) having a diameter of 6 μm were applied, instead of artificial graphite particles having a diameter of 10 μm.

### EXAMPLE 4

### Manufacture of Lithium Metal Secondary Battery Having Electrode Plate Constituted Without Using Conductive agent in Composite Anode of Lithium Metal Particles-MCMB Particles

An anode and a lithium metal secondary battery including the anode were manufactured in the same manner as in Example 1, except that 5 wt % of polyvinylidene fluoride as a binder was dissolved in NMP without using a conductive agent and then 95 wt % of the lithium metal-MCMB composite was mixed therein to prepare a slurry.

### COMPARATIVE EXAMPLE 1

A lithium metal secondary battery was manufactured in the same manner as in Example 1, except that the lithium metal foil was applied as an anode.

### COMPARATIVE EXAMPLE 2

### Manufacture of Lithium Metal Secondary Battery Applying Only Lithium Metal Particle and Conductive agent to Constitute Electrode Plates

An anode and a lithium metal secondary battery including the anode were manufactured in the same manner as in Example 1, except that 5 wt % of polyvinylidene fluoride as a binder was dissolved in NMP, and then 95 wt % of a lithium metal-conductive agent composite having a ratio of the lithium metal:the conductive agent=80:20 (weight ratio) was mixed therein to prepare a slurry. In this case, the conductive agent used was amorphous carbon having an average particle diameter of 25 nm

### EXPERIMENTAL EXAMPLE 1

### Evaluation of Performance of Lithium Metal Secondary Battery

Changes in discharge capacity according to the cycle of lithium metal secondary batteries prepared in Examples 1 to 4 were evaluated, and the results are shown in FIG. 6. Lithium metal secondary batteries in Comparative Examples 1 and 2 were used as a control group.

As a result of experiment, lithium metal secondary batteries in Examples 1 to 4 maintained 90% or more of the initial capacity at the 10 cycle during charge/discharge at a current condition of C/2 (2mA) while the lithium secondary battery in Comparative Example 1, including a lithium metal foil anode exhibited about 80% of the initial capacity, and the battery in Comparative Example 2, in which lithium metal particles and carbon particles having different average particle diameters were used in the anode, exhibited about 85% of the initial capacity (see FIG. 6). Accordingly, it can be confirmed that the lithium metal secondary battery of the present invention including a lithium metal-based anode in which lithium metal particles and carbon particles having an equivalent size with each other were used could significantly improve the cycle life-span properties of the battery without any chemical damage.

From the foregoing, it will be appreciated that various embodiments of the present invention have been described herein for purposes of illustration, and that various modifications may be made without departing from the scope and spirit of the present invention. Accordingly, the various embodiments disclosed herein are not intended to be limiting, with the true scope and spirit being indicated by the following claims.

What is claimed is:

1. An anode for a lithium metal secondary battery, comprising:
a current collector; and
an anode layer that is formed on the current collector and contains lithium metal particles and carbon particles,
wherein the anode layer comprises lithium metal particles having an average particle diameter of from 5 μm to 50 μm and carbon particles having an average particle diameter of from 5 μm to 30 μm, the lithium metal particles and the carbon particles being uniformly mixed with each other to be physically linked.

2. The anode for a lithium metal secondary battery of claim 1, wherein a mixing ratio of the lithium metal particles and carbon particles is in a range of 1-99:99-1 (weight ratio).

3. The anode for a lithium metal secondary battery of claim 1, wherein the lithium metal particles are a core-shell structure comprising lithium metal particles and a surface protective layer which surrounds the lithium metal particles and comprises wax or silicon oil.

4. The anode for a lithium metal secondary battery of claim 1, wherein the carbon particles are at least one selected from the group consisting of graphite, hard carbon and soft carbon.

5. The anode for a lithium metal secondary battery of claim 1, wherein the anode layer is formed by coating or screen printing a slurry or paste comprising lithium metal particles and carbon particles on a current collector.

6. The anode for a lithium metal secondary battery of claim 1, wherein the anode layer further comprises a conductive agent.

7. A lithium metal secondary battery, comprising:
an anode comprising an anode layer in which lithium metal particles having an average particle diameter of from 5 μm to 50 μm and carbon particles having an average particle diameter of from 5 μm to 30 μm are uniformly mixed with each other to be physically linked;
a cathode;
a separator interposed between the cathode and the anode; and
an electrolyte injected therebetween.

8. The lithium metal secondary battery of claim 7, wherein the cathode comprises, as a cathode active material, a lithium-containing metal composite oxide selected from the group consisting of olivine (LiFePO₄), lithium cobalt oxide (LiCoO₂), lithium nickel oxide (LiNiO₂) and lithium manganese oxide (LiMn₂O₄), a mixture of the lithium-containing metal composite oxide, a solid solution of the lithium-containing metal composite oxide, or a material with aluminum, iron, copper, titanium, and magnesium substituted in the solid solution.

9. The lithium metal secondary battery of claim 7, wherein the separator is a polyethylene-based single film or a multilayer film of polyethylene and polypropylene.

10. The lithium metal secondary battery of claim 7, wherein the electrolyte comprises a lithium salt and an organic solvent and the organic solvent is at least one solvent selected from the group consisting of ethylene carbonate, propylene carbonate, dimethyl carbonate, diethyl carbonate, ethyl methyl carbonate, tetrahydrofuran, 2-methyltetrahydrofuran, dimethoxyethane, methyl formate, ethyl formate, and γ-butyrolactone.

11. The lithium metal secondary battery of claim 10, wherein the lithium salt is at least one selected from the group consisting of lithium perchlorate (LiClO₄), lithium triflate (LiCF₃SO₃), lithium hexafluorophosphate (LiPF₆), lithium tetrafluoroborate (LiBF₄), and lithium trifluoromethanesulfonyl imide (LiN(CF₃SO₂)₂).
